(19) United States
(12) Patent Application Publication
(10) Pub. No.: US 2009/0240829 A1
(43) Pub. Date: Sep. 24, 2009

(54) TRANSLATING BETWEEN IMPLICIT AND EXPLICIT PUBLISH-SUBSCRIBE PROTOCOLS

(75) Inventor: Joseph J. Hildebrand, Littleton, CO (US)

Correspondence Address: CESARI AND MCKENNA, LLP, 88 BLACK FALCON AVENUE, BOSTON, MA, 02210, US

(73) Assignee: Cisco Technology, Inc., San Jose, CA (US)

(21) Appl. No.: 12/406,719

(22) Filed: Mar. 18, 2009

Related U.S. Application Data
(60) Provisional application No. 61/037,545, filed on Mar. 18, 2008.

(51) Int. Cl. G06F 15/16

(52) U.S. Cl. 709/232

(57) ABSTRACT

In one embodiment, a translating publish-subscribe (pub-sub) server may be configured to receive a subscribe request from a subscriber device according to an original pub-sub model. The server may then convert the received subscribe request into a pub-sub subscribe request of a second pub-sub model, and may transmit the converted received subscribe request to publisher servers operating according to the second pub-sub model.

### RELATED APPLICATION

This application claims priority from U.S. Provisional Patent Application Ser. No. 61/037,545, entitled SYSTEM AND METHOD FOR PROVIDING PRESENCE, filed on Mar. 18, 2008 by Hildebrand, et al., the contents of which are incorporated by reference in its entirety.

### TECHNICAL FIELD

The present disclosure relates generally to computer networks, and, more particularly, to publish-subscribe protocols in computer networks.

### BACKGROUND

In its simplest form, ‘presence’ is the availability of any person, application, or device to exchange information with any other person, application, or device (hereinafter collectively referred to as ‘components’). Extended presence comprises contextual attributes that change over time, which attributes may convey a component's geographic location, differing levels of availability, capability, and role.

Generally, information, such as presence, may be distributed among interested devices through one of either an implicit publish-subscribe (pub-sub) protocol or an explicit pub-sub protocol. An implicit protocol, such as the well-known Personal Eventing via Publish-subscribe (PEP) extension to the Extensible Messaging and Presence Protocol (XMPP) generally operates by having a client request types of services (e.g., presence notifications) that the client is interested in. Then, based on other clients' publish configuration, such as allowing interested clients to see their location and/or availability, a centralized server implicitly pairs the pub-sub connections. For instance, assume a client “A” wishes to know location and availability of users (i.e., subscribes to location and availability), and that a user “B” shares (i.e., publishes) only its location, a user “C” shares only its availability, and a user “D” shares both its location and availability. Through implicit pub-sub, the centralized server will map the publish/subscribe configurations, and client A will implicitly be subscribed by the server to user B's location, user C's availability, and both user D's location and availability.

On the other hand, according to an explicit protocol (e.g., the well-known Session Initiation Protocol, “SIP”), client A would be required to subscribe directly to each other user's location and availability. As such, client A would send a subscribe request to user B's availability and location, and user B, only publishing its location, would only allow subscription to the location (thus denying client A's subscription to user B's availability). Similarly, user C would only allow a subscription to its availability, while user D would allow client A's subscription to both its location and availability. Currently, devices and their underlying networks operate according to either the implicit pub-sub model or the explicit pub-sub model, and the models have not been interchangeable.

### BRIEF DESCRIPTION OF THE DRAWINGS

The advantages of the invention may be better understood by referring to the following description in conjunction with the accompanying drawings in which like reference numerals indicate identically or functionally similar elements, of which:

FIG. 1 illustrates an example computer network;

FIG. 2 illustrates an example network device;

FIGS. 3A and 3B illustrate examples of pub-sub message translation and exchange;

FIG. 4 illustrates an example system for converting between Session Initiation Protocol (SIP) presence and Extensible Messaging and Presence Protocol (XMPP) presence;

FIG. 5 illustrates an example block diagram showing a SIP presentity publishing presence information to an XMPP presentity;

FIG. 6 illustrates an example data flow diagram showing protocol translation during the presence information exchange of FIG. 5;

FIG. 7 illustrates a block diagram showing a SIP watcher subscribing to an XMPP presentity's location information;

FIG. 8 illustrates a data flow diagram showing an example protocol translation during the information exchange of FIG. 7.

FIG. 9 illustrates a block diagram showing a SIP watcher subscribing to an XMPP presentity's presence information;

FIG. 10 illustrates a data flow diagram showing an example protocol translation during the information exchange of FIG. 9.

FIG. 11 illustrates an example simplified procedure for generally translating between explicit and implicit pub-sub protocols;

FIG. 12 illustrates an example procedure for translating from an implicit pub-sub protocol to an explicit pub-sub protocol; and

FIG. 13 illustrates an example procedure for translating from an explicit pub-sub protocol to an implicit pub-sub protocol.

### DESCRIPTION OF EXAMPLE EMBODIMENTS

### Overview

According to one or more embodiments of the disclosure, a translating publish-subscribe (pub-sub) server may be configured to receive a subscribe request from a subscriber device according to an original pub-sub model (e.g., explicit or implicit). The server may then convert the received subscribe request into a pub-sub subscribe request of a second pub-sub model (e.g., implicit or explicit, respectively), and may transmit the converted received subscribe request to publisher servers operating according to the second pub-sub model. In one or more embodiments where the original pub-sub model is an explicit pub-sub protocol, the translating pub-sub server may generate explicit pub-sub subscribe responses for the implicit publisher servers, and transmits them to the explicit subscriber device, accordingly.

### Description

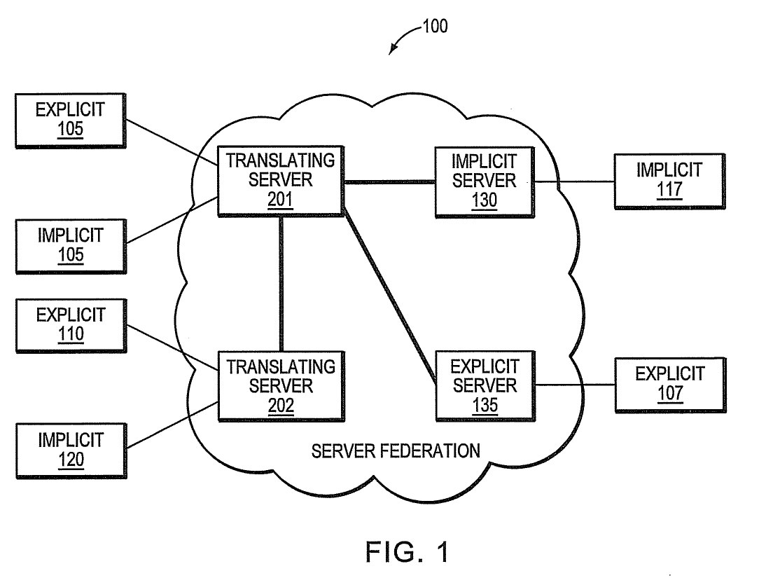

FIG. 1 is a schematic block diagram of an example computer network 100 illustratively comprising nodes/devices, such as one or more devices operating according to an explicit publish-subscribe (pub-sub) protocol (devices 105, 107, and 110), and other devices operating according to an implicit pub-sub protocol (devices 115, 117, and 120), as described herein. For instance, devices may be a personal computer (PC) or one or more peripheral devices, such as phones, pagers, etc., as well as any other device capable of and configured to participate in a pub-sub protocol.

The collective devices are interconnected by links/network 100 as shown, which may comprise a federation of one or more pub-sub servers in accordance with one or more techniques as described further herein. Illustratively, implicit device 117 is connected to an implicit pub-sub server 130 and explicit device 107 is connected to an explicit pub-sub server 135, in a conventional manner. Conversely, explicit device 105 and implicit device 115 may be connected with a translating pub-sub server 201, and explicit device 110 and implicit device 120 may be connected with a translating pub-sub server 202, as described herein. Those skilled in the art will understand that any number of nodes, devices, links, etc. may be used in the computer network, and that the view shown herein is for simplicity and illustration (e.g., from a connection standpoint of illustrative translating pub-sub server 201).

In this environment, a number of devices may interact to share particular information, such as presence (or enhanced presence) information, as may be understood by those skilled in the art. In particular, each device (105-120) may, though need not, comprise an electronic device with capability for visual and/or auditory presentation. Thus, a device can be, for example, a desktop personal computer (PC), a laptop computer, a workstation, a personal digital assistant (PDA), a wireless telephone, a smart phone, an Internet television, and the like. Each device with a human-user interface may support communication by a respective participant/user, in the form of a suitable input device (e.g., keyboard, mouse, stylus, keypad, etc.) and output device (e.g., monitor, display, speech, voice, or other device supporting the presentation of audible/visual information). Other non-human-interfaced devices (e.g., servers, autonomous processing devices, etc.) may also be found within network 100, as either an implicit device or an explicit device. Each device may be interconnected with a suitable communications network 100 such as, for example, the Internet, and may appear as a client computer thereon.

Network 100 may comprise or be supported by one or more suitable communication networks, such as, for example, a telecommunications network that allows communication via one or more telecommunications lines/channels. In particular, the communication or data networks, such as the Internet, may be used to deliver content, such as for the collaborative computing sessions herein. The Internet is an interconnection of computer clients and servers located throughout the world and exchanging information according to Transmission Control Protocol/Internet Protocol (TCP/IP), Internetwork Packet eXchange/Sequence Packet eXchange (IPX/SPX), AppleTalk, or other suitable protocol. The Internet supports the distributed application known as the “World Wide Web.” Web servers maintain websites, each comprising one or more web pages at which information is made available for viewing and audio/hearing. Each website or web page may be supported by documents formatted in any suitable conventional markup language (e.g., HTML or XML). Information may be communicated from a web server to a client using a suitable protocol, such as, for example, Hypertext Transfer Protocol (HTTP) or File Transfer Protocol (FTP).

In one embodiment, each device may operate under the control of a suitable operating system (OS) (e.g., WINDOWS, UNIX, etc.) to run software applications, which may be installed, received, or downloaded. At least some of these software applications may support specific functions, such as, for example, functions related to pub-sub protocols as understood by those skilled in the art and as further described herein.

The pub-sub functionality may be supported by a federation of one or more corresponding servers, which according to one or more embodiments herein, comprise at least one translating pub-sub server (e.g., 201 and 202), generally referred to herein as server 200. In particular, as described herein, pub-sub devices and their underlying networks have generally operated according to either an implicit pub-sub model (servers 130) or an explicit pub-sub model (servers 135), and the models have not been interchangeable. The server(s) 200 may be a computer system that is connected to network 100, and which may comprise and appear as one or more server computers thereon to store information (e.g., content) and perform the translating functions as described in detail below. Further, in some embodiments, certain application modules used for pub-sub operation may be downloadable to the participant devices from the server 200.

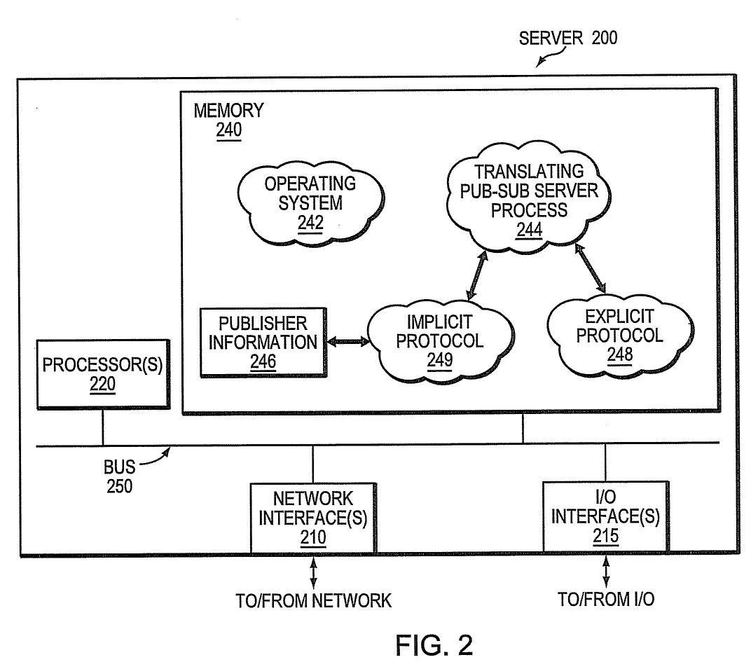

FIG. 2 illustrates a schematic block diagram of an example server 200 that may be advantageously used with one or more embodiments described herein, e.g., for translating between explicit and implicit pub-sub protocols/networks (e.g., servers 201 and/or 202). In particular, the server 200 comprises one or more network interfaces 210, one or more input/output (I/O) interfaces 215, one or more processors 220, and a memory 240 inter-connected by a system bus 250. The network interfaces 210 contain the mechanical, electrical, and signaling circuitry for communicating data over physical/wireless links coupled to the network 100. The network interface(s) may be configured to transmit and/or receive data using a variety of different communication protocols suitable for the network. Also, I/O interfaces 215 contain the mechanical, electrical, and signaling circuitry for communicating with one or more user interface devices, such as a mouse, keyboard, monitor/screen, etc. (not explicitly shown).

The memory 240 comprises a plurality of storage locations that are addressable by the processor(s) 220 and the network interfaces 210 for storing software programs associated with the embodiments described herein. The processor(s) 220 may comprise necessary elements or logic adapted to execute the software programs and manipulate the data structures, such as tables for storing publisher information 246, described herein. An operating system 242, portions of which are typically resident in memory 240 and executed by the processor(s), functionally organizes the device by, inter alia, invoking operations in support of software processes and/or services executing on the device (e.g., for pub-sub protocol operation as used herein). In particular, these software processes and/or services may comprise a pub-sub server process 244, which illustratively for the translating pub-sub server(s) has both an explicit protocol component 248 and an implicit protocol component 249. It will be apparent to those skilled in the art that other types of processors and memory, including various computer-readable media, may be used to store and execute program instructions pertaining to the inventive technique described herein.

The pub-sub server process 244 may contain computer executable instructions executed by the processors 220 to generally perform functions to manage or control various processes or aspects of pub-sub protocols and the translation techniques described herein. In particular, as noted above, pub-sub devices have generally operated according to only one of either an implicit pub-sub protocol or an explicit pub-sub protocol. Accordingly, the network 100 has been divided into disparate networks, one for communicating implicit pub-sub requests and responses, and another for communicating explicit pub-sub requests and responses. Thus, those devices operating according to the implicit pub-sub model have not been able to communicate pub-sub information (e.g., presence) with devices operating according to the explicit pub-sub model, and those devices operating according to the explicit pub-sub model have not been able to communicate pub-sub information with devices operating according to the implicit pub-sub model.

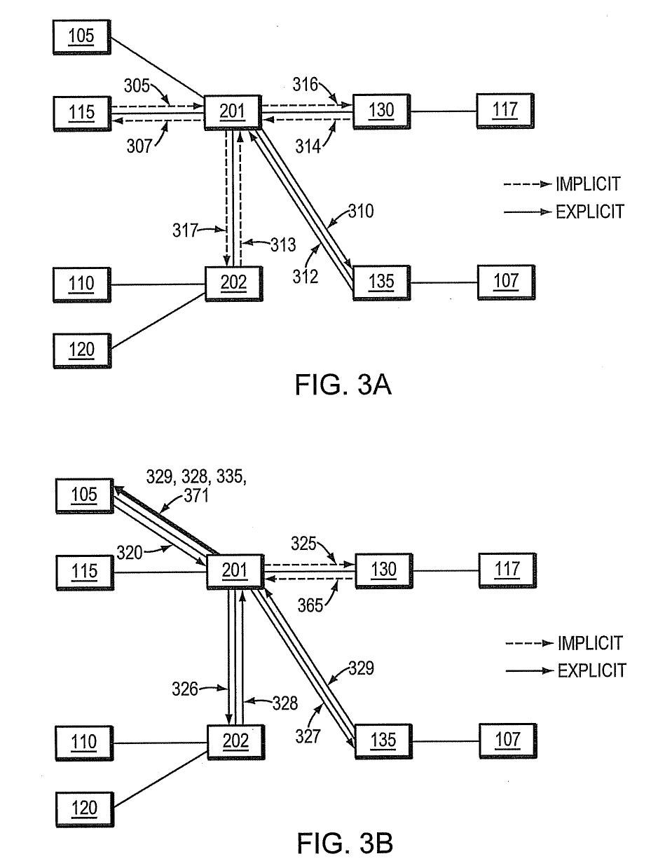

According to one or more embodiments of the disclosure, therefore, a translating pub-sub server 200 may be configured to receive either an implicit pub-sub subscribe request or an explicit pub-sub subscribe request from a subscriber device. The pub-sub subscribe request may then be converted into an opposite pub-sub subscribe request, being either corresponding new explicit pub-sub subscribe requests or corresponding new implicit pub-sub subscribe requests, respectively, as needed. The pub-sub server may then transmit explicit pub-sub subscribe requests to explicit publisher servers or may transmit implicit pub-sub subscribe requests to implicit pub-sub servers. Explicit pub-sub subscribe responses may be generated where necessary for implicit publisher servers, and then transmitted to an explicit subscriber, accordingly. In particular, the details of the server's translation/conversion services are described below with reference to FIGS. 3A-13.

Illustratively, the techniques described herein may be performed by hardware, software, and/or firmware, such as in accordance with translating pub-sub server process 244, which may contain computer executable instructions executed by the processor 220 to perform functions relating to the novel techniques described herein, e.g., in conjunction with explicit protocol component 248 and implicit protocol component 249, generally operating in accordance with conventional protocol functionality. In other words, the translating pub-sub server process 244 may be operable to translate between the two protocols 248 and 249, accordingly. Notably, while the description assumes that translation may occur from implicit to explicit and explicit to implicit at the same server, one or more embodiments herein may configure the server 200 to operate according to only one method of translation, i.e., either from implicit to explicit or from explicit to implicit, but not both (e.g., depending upon the desired implementation within network 100).

Operationally, in one embodiment as shown in FIG. 3A, the server 201 may receive an implicit pub-sub subscribe request 305 from an implicit subscriber device (e.g., 115). Accordingly, the translating server 201 may convert the received request 305 into an opposite pub-sub subscribe request, namely, one or more corresponding new explicit pub-sub subscribe requests 310 (note that implicit messages are shown as dashed lines, while explicit messages are shown in solid lines) to appropriate explicit servers 135, while simply forwarding the un-translated implicit subscribe request 305 to any implicit servers 130. Note that when communicating with another translating server 202, a default pub-sub model may be used (either implicit or explicit) as configured on the local server to the requesting device 105 (described below). In particular, to translate the subscribe request 305, the server 201 may examine the implicit subscribe request 305, and may determine particular requested subscription interests therein. For example, assume that implicit device 115 desires to subscribe to location and availability of devices (users). The server 201 may thus generate a new explicit pub-sub subscribe request for each interest, e.g., one for location and one for availability, and transmits the new explicit pub-sub subscribe requests 310 to one or more explicit publisher servers (e.g., 135) on behalf of the subscriber device 115. In essence, the server 201 acts as an explicit subscriber for the implicit device 115. In this manner, the pub-sub server 201 may receive explicit pub-sub subscribe responses 312 from the explicit publisher servers, for example, allowing location subscription to device 105 (e.g., through internal translation based on known publisher information 246), and availability subscription to device 110 (via the response 312).

Note that in this example, the default pub-sub model is to utilize the implicit pub-sub model, or, simply to use the model of the incoming subscribe request. As such, an implicit subscribe request 117 is also sent to translating server 202, which may respond to the subscribe request with an implicit subscribe response 313 for both the implicit device 120 and the explicit device 110 (e.g., allowing and/or disallowing/rejecting certain subscriptions). In addition, according to conventional implicit protocol operation, an implicit subscribe request 116 may be sent to implicit server 130, which may respond with an implicit subscribe response 314.

The server may optionally convert the explicit pub-sub subscribe responses 312 and implicit subscribe responses 313 and 314 into an implicit pub-sub subscribe response 307, and transmit the implicit pub-sub subscribe response 307 to the subscriber device 115. As such, the explicit devices 105, 107, and 110 have explicitly allowed subscription to their particular published information (that is, their corresponding servers have allowed the subscription) in addition to the implicit devices (i.e., their servers), and the implicit subscriber device 115 has been informed of what publications to expect (assuming there are such provisions in the underlying implicit pub-sub protocol operation—general implicit protocols have no implicit subscribe response).

FIG. 3B illustrates the converse example, where the translating pub-sub server 201 receives an explicit pub-sub subscribe request 320 from an explicit subscriber device (e.g., 105). Accordingly, the server 201 may convert the received request 320 into an opposite pub-sub subscribe request as necessary, namely, a corresponding new implicit pub-sub subscribe request 325 for any interconnected implicit servers (e.g., 130). In particular, the server 201 may determine a requested subscription interest within the explicit pub-sub subscribe request 320 (e.g., explicitly requesting device availability), and may convert this interest into the corresponding new implicit pub-sub subscribe request, and transmits the subscribe request 325 to the implicit server 130, accordingly. Illustratively, the server 201 may have also previously received implicit pub-sub publish messages 330 from one or more managed implicit publisher devices (e.g., 115) that indicate the implicit allowances of the implicit publisher devices, as stored in publisher information 246. Thus, by determining implicit allowances of implicit publisher devices, such as by performing a lookup operation into the memory location for implicit allowances in 246, the server 201 may generate explicit pub-sub subscribe responses 335 (on behalf of the implicit publishers) based on the implicit allowances, such that an explicit subscription to device 115's availability is transmitted to the explicit subscriber device 105.

The remaining explicit servers may be sent an un-translated explicit subscribe request (326 and 327) in a conventional manner (e.g., where the default translating-to-translating server model uses the incoming received request to determine pub-sub model). As such, explicit subscribe responses 328 and 329 may be returned from explicit servers (e.g., including a translated implicit subscribe response from implicit device 120 at translating server 202), and an implicit subscribe response 365 is returned from implicit server 130. The subscribe responses may all be sent to the requesting explicit device as explicit subscribe responses, i.e., where implicit subscribe responses (365) are translated (e.g., generated for implicit servers) accordingly (to explicit subscribe response 371).

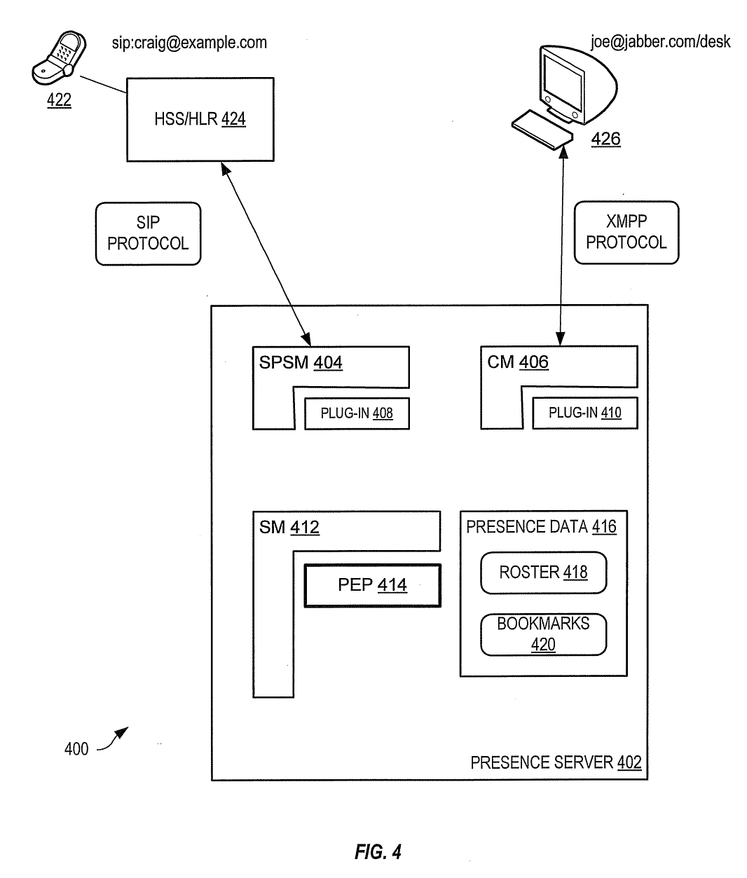

A more specific example of pub-sub protocol translation is now described in detail with reference to FIGS. 4-10, illustrating pub-sub protocols as they apply to presence information, according to one or more particular embodiments herein. For instance, FIG. 4 shows one exemplary system 400 for converting between the “Session Initiation Protocol” (SIP) and the “Extensible Messaging and Presence Protocol” (XMPP), as will be understood by those skilled in the art (and whose general terms are used herein in their conventional sense, unless otherwise indicated). Generally, in SIP, a device may explicitly subscribe to presence information (e.g., phone on/off hook, user available/busy, etc.). For example, when a SIP device is online, it may explicitly subscribe to various information from other explicitly operated devices. Conversely, in XMPP, a device may implicitly subscribe to the presence information. For example, when an XMPP device is online, it may declare its presence, and a centralized server may implicitly establish subscriptions for the device from other implicitly operated devices.

As shown in FIG. 4, system 400 comprises a presence server 402 (e.g., a more specific example of pub-sub server 200) that includes a connection manager 406, a session manager (SM, e.g., a Jabber SM or “JSM”) 412 and presence data 416. Connection manager 406 operates to route presence information between external devices, such as a desktop computer 426 and SM 412. SM 412 operates to maintain presence information, stored in presence data 416, for device 426. Presence data 416 may also include a roster 418 and bookmarks 420. In this example, roster 418 stores presence configuration information of the user of device 426. Bookmarks 420 may provide available references for the user of device 426, such that these bookmarks are available for a user regardless of how the user connects to presence server 402.

In the FIG. 4 example, mobile phone 422 is connected to a home subscriber server/home location register (“HSS/HLR”) 424 which maintains status information, such as location and availability, of the phone 422. For example, as mobile phone 422 travels to different cells within a provider network, HSS/HLR 424 is automatically updated such that the location of, and hence connectivity to, mobile phone 422 is known, thus allowing calls to be connected to the mobile phone. HSS/HLR 424 provides routing information and availability of mobile phone 422 within the provider network, utilizing a session initiation protocol (SIP) to manage this presence information.

SIP utilizes a generic event model that is based upon occurring events. SIP includes event packages that may be subscribed to by one or more users to receive associated event information. “Presence” is one such event package that allows device presence to be implemented within SIP. Other SIP events are similar to, but not exactly the same as, presence status information within XMPP.

Personal Eventing via Publish-subscribe (PEP) can be implemented using the XMPP Publish-Subscribe extension (“pub-sub”) to broadcast state change events associated with an XMPP account or user [e.g., according to XEP-0163; “XEP” denotes a draft or final standard of the XMPP Standards Foundation, as will be understood by those skilled in the art]. By transcribing both publish and subscribe SIP events into PEP publish and subscribe events, mobile phone 422 may publish within SIP and desktop computer 426 may subscribe within XMPP (and vice versa). Presence server 402 thus manages automatic translation and mapping of SIP events to XMPP events. By translating events between SIP and XMPP, disparate networks may operate together to share presence information.

Protocol translation, between SIP and XMPP, may be implemented within a SIP presence services module (SPSM) 404 of presence server 402. In particular, SPSM 404 may include one or more plug-ins 408 to implement certain aspects of protocol translation. For example, one plug-in (e.g., plug-in 408) may allow certain SIP event types to be translated to certain XMPP event types. As new specific event packages and features are added to either the SIP protocol and/or the XMPP protocol, additional plug-ins may be added to SPSM 404 to provide protocol translation. Since XML for an event type within SIP is not the same as XML for the associated event type within XMPP, mapping between SIP and XMPP is not straightforward. The semantics of SIP and XMPP are not identical, and therefore the mapping between the two protocols is not necessarily one-to-one.

For example, the subscribe event within SIP has a state associated with it. That is, a server supporting SIP must maintain a state that indicates that a user has that particular subscription. The server then authorizes and published associated events on a per subscription basis. XMPP, on the other hand, allows a client to declare the types of events that the client is interested in, which constitutes an implicit interest in subscribing to another client's published information. Thus, within XMPP, there is significantly less traffic associated with subscriptions and publications, since a client does not need to specifically (i.e., explicitly) subscribe to each event of interest.

In XMPP, a client declares interest in certain information from identified sources and sends that declaration to other servers. These servers then match the client's declared interests to the identified sources' willingness to share that published information. For example, if a first client is interested in geographic location information and availability of clients within his/her ‘friends’ list, the first client's interests are sent to servers of each of the clients within that list. Assume in this example that a second client, identified within the first client's ‘friends’ list, is willing to publish his/her availability and geographic location to the first client. In this case, changes in geographic location of the second client will be published to the first client. If a third client, also in the ‘friends’ list of the first client, is willing only to publish availability to the first client, then only changes in availability of the third client are published to the first client. If a fourth client, also in the ‘friends’ list of the first client, is willing to publish geographic information and current activity to the first client, only geographic location information is published to the first client since the first client has no interest in current activity. Thus, there are significant differences between SIP and XMPP events for publication and subscription.

Within XMPP, and PEP in particular, a client's capabilities may be associated with each system device. For example, the following stanza illustrates how device capability is defined within XMPP (e.g., see XEP-0115: Entity Capabilities):

```
<presence from=‘joe@jabber.com/desk>
  <c xmlns=‘http://jabber.com/protocol/caps’
  hash=‘sha-1’
  node=‘http://jabber.com/clients/patent’
  ver=’ qKbMdYLghbiDwlCN/3MaNf/ni6c=’/>
</presence>
```

By querying the “joe@jabber.com/desk” client, the capabilities associated with the node identity “http://jabber.com/clients/patent” are returned. For example, the client may return:

<feature var=‘http://jabber.com/protocol/geoloc+notify/>

In an example taken from XEP-0115: Entity Capabilities, assume a person named Romeo becomes available. In order for Romeo's client to publish his capabilities, his client adds a <c/> element to Romeo's presence packets. As a result, a third-party client receives the following presence packet from Romeo's presence server:

```
<presence from=‘romeo@montague.lit/orchard’ >
  <c xmlns=‘http://jabber.org/protocol/caps’
  hash=‘sha-1’
  node=‘http://code.google.com/p/exodus’
  ver=‘SrFo9ar2CCk2EnOH4q4QANeuxLQ=’/>
</presence>
```

The “node” attribute represents the client Romeo is using, and the “ver” attribute represents the specific version of this client. At this point, the third-party client may have no idea what the capabilities associated with a client string “http://exodus.jabberstudio.org/caps” and a version string “SrFo9ar2CCk2EnOH4q4QANeuxLQ=” are. The third-party client may, therefore, send a query to Romeo's server, asking what this identified client version can do (using service discovery):

```
<iq from=‘juliet@capulet.lit/balcony’
  id=‘disco1’
  to=‘romeo@montague.lit/orchard’
  type=‘get’>
  <query xmlns=‘http://jabber.org/protocol/disco#info’
node=‘http://code.google.com/p/
exodus#SrFo9ar2CCk2EnOH4q4QANeuxLQ=’/>
</iq>
```

The response is:

```
<iq type=‘result’ from=‘romeo@montague.net/home’ id=‘1’>
  <query xmlns=‘http://jabber.org/protocol/disco#info’
    node=‘http://exodus.jabberstudio.org/caps#0.9’>
  <identity category=‘client’ type=‘pc’/>
  <feature var=‘http://jabber.org/protocol/disco#info’/>
  <feature var=‘http://jabber.org/protocol/disco#items’/>
  <feature var=‘http://jabber.org/protocol/feature-neg’/>
  <feature var=‘http://jabber.org/protocol/muc’/>
  </query>
</iq>
```

At this point, the third-party client knows that anyone advertising a version string of “SrFo9ar2CCk2EnOH4q4QANeuxLQ=” has a client that can engage in MUC (multi-user chat) and other listed features. The third-party client remembers this information, such that it does not need to explicitly query the capabilities of other users having the exact same client and version string.

Thus, by implementing a translation from SIP to XMPP, features associated with XMPP become available to users of SIP, and implicit subscriptions in XMPP may be translated to explicit subscriptions in SIP.

Within XMPP, a roster is a group of people to whose presence one subscribes, or from whom one allows subscriptions, or both. Each person in the roster has a subscription state of: none, subscribe to, allow subscription from, or both subscribe to and allow subscription from. These subscriptions are durable and last until they are revoked. Subscriptions are maintained when the client logs in and out and even if the server becomes non-operational. When a client comes online (i.e., when the client logs in, authenticates, etc.), the client sends a presence stanza identifying itself to a presence server that turns on the flow of presence. This initial presence stanza has two effects: all people subscribed to the client's presence receive an update as to the client's new logged-in status; and the presence server requests presence information from all clients to which this client subscribes to receive presence information from.

SIP retrieves a resource list (similar to the roster in XMPP) and then the client's device sends a subscribe request to each of the people on the client's resource list. In XMPP, where people identified by the roster are local (i.e., subscribed to the same presence server as the client), the presence information is also held locally and therefore sent to the client immediately. Where the people identified in the client's roster are not local, a probe is sent out to each other identified server to request the presence information. Where multiple people are on the same external server, the requests may be batched to reduce network traffic. Thus, the initial presence information received from the client results in one or more implicit subscriptions. These implicit XMPP subscriptions may be translated to explicit SIP subscriptions where the roster identifies a SIP user.

A further translation anomaly arises because, within XMPP, presence is handled independently of PEP. That is, the presence functionality does not require the use of PEP within XMPP. Within XMPP, a presence server maintains presence data for each presentity external to PEP. Each presentity may also have one or more rosters and bookmarks.

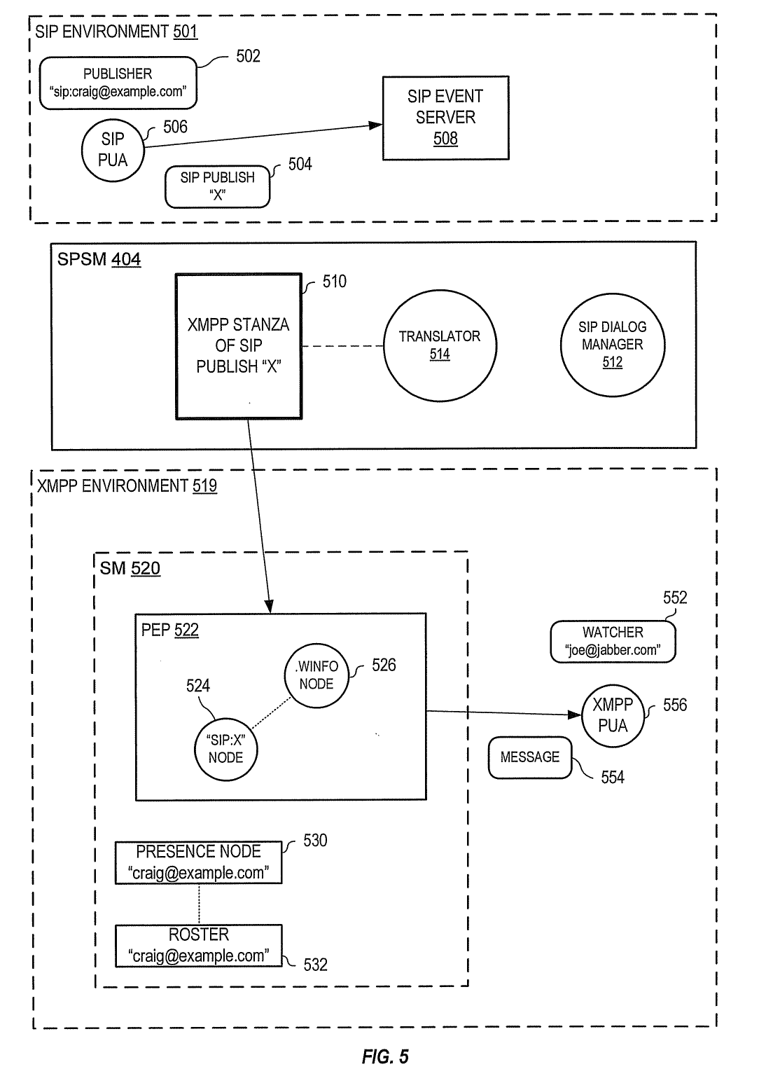

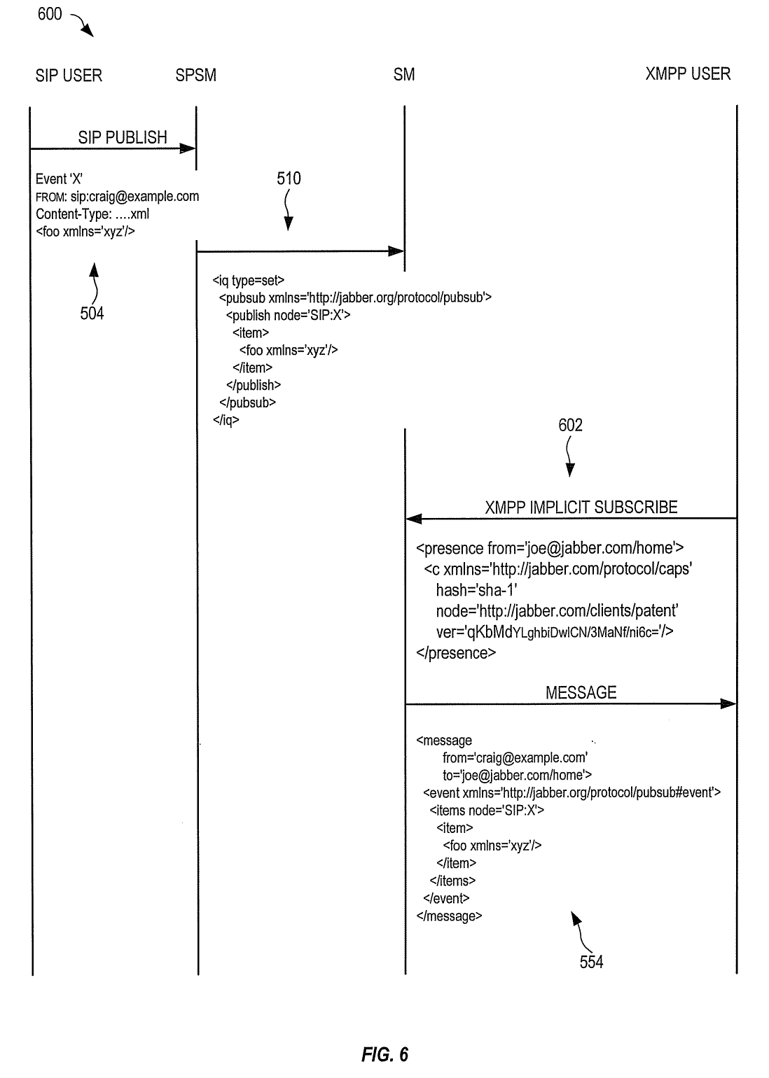

FIG. 5 is a block diagram showing a SIP presentity publishing presence information to an XMPP presentity, in an embodiment. FIG. 6 is a data flow diagram illustrating exemplary protocol translation during the presence information exchange of FIG. 5. FIGS. 5 and 6 are best viewed together with the following description. In FIGS. 5 and 6, information is exchanged between a SIP PUA 506, SPSM 404, an SM 520 and an XMPP PUA 550 to publish SIP events within an XMPP environment 519. SM 520 has a base ID of “jabber.com” in this example.

SPSM 404 is shown with a SIP dialog manager 512 that maintains dialogs between SM 520 and SIP presentities as required by SIP environment 501. For example, SIP dialog manager 512 may provide dialog handshaking and associated timeouts for communication between SIP environment 501 and SPSM 504. Although shown within SPSM 404, SIP dialog manager 512 may be located elsewhere without departing from the scope hereof.

In one example of operation, a SIP presence user agent (PUA) 506 determines a presence change in a presentity 502, named “X”, and generates a SIP publish packet 504. SIP publish packet 504 is sent to a SIP event server 508 that manages SIP events within the SIP environment. SIP publish packet 504 is also received by SPSM 404 where it is converted into an appropriate XMPP protocol stanza 510. As shown in FIG. 6, XMPP stanza 510 utilizes a personal eventing via pub-sub (PEP) service 522 within a session manager 520 to publish a PEP node 524 within XMPP environment 519, based upon information within SIP publish packet 504. In translating SIP publish packet 504 into XMPP stanza 510, SPSM 404 attaches a prefix of “SIP:” to the SIP event name “X”. Thus, within XMPP environment 519, SIP publish event 504 is identified as “SIP:X”. In particular, the use of the “SIP:” prefix in association with a name within XMPP environment 519 indicates that the name corresponds to an entity within SIP environment 501 and is handled accordingly.

Assume that SIP PUA 506 associated with address sip:user@example.com maintains within SM 520 a roster 532 permitting XMPP watcher named joe@jabber.com 552 (illustratively shown and hereinafter optionally referred to as “Joe”) to see PEP node SIP:X 524. Assume further that XMPP watcher Joe 552 has implicitly subscribed to presence node SIP:X 524 for user@example.com. SM 520 operates to dispatch messages indicating presence status changes associated with SIP presence node 524 to an XMPP PUA 556 associated with watcher Joe 552. Thus, SM 520 sends a message 554 to XMPP PUA 556 to inform watcher Joe 552 of availability presence changes occurring for SIP presence node 524. Such presence availability changes occur within SIP presence node 524 as a result of SIP publish packets (e.g., SIP publish packet 504) for SIP publisher 502. As shown in the example of FIG. 6, the item information contained within SIP publish packet 504 (i.e., “<foo xmlns=‘xyz’/>”) may also be delivered within message 554 to presentity 552.

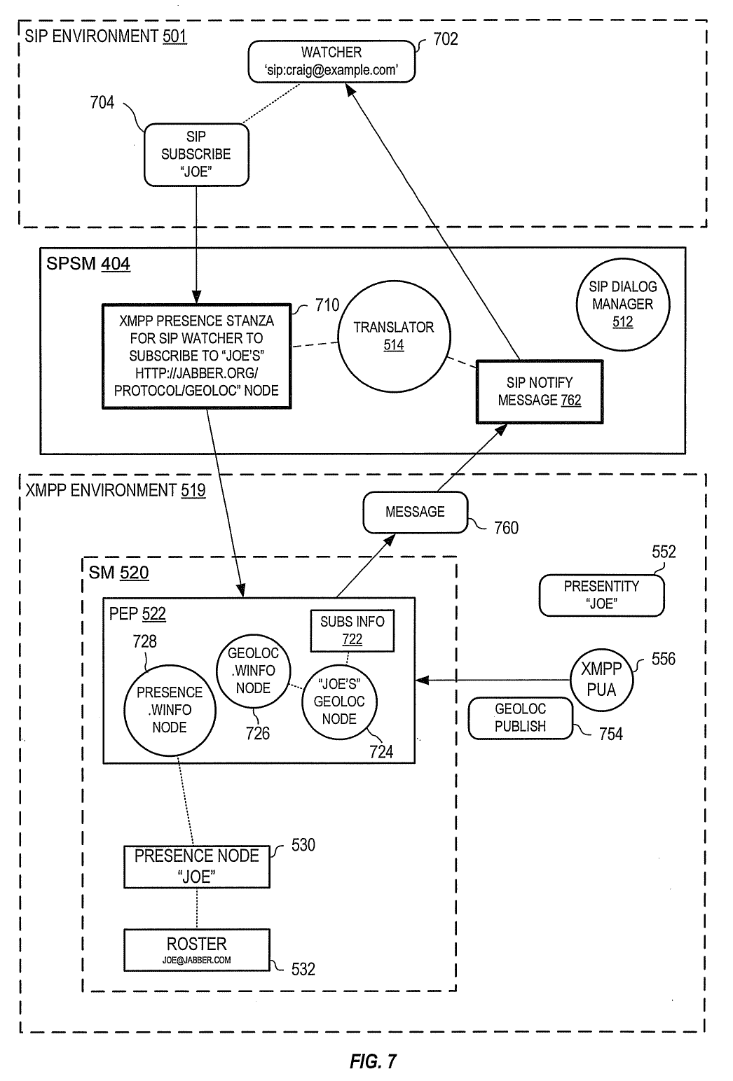

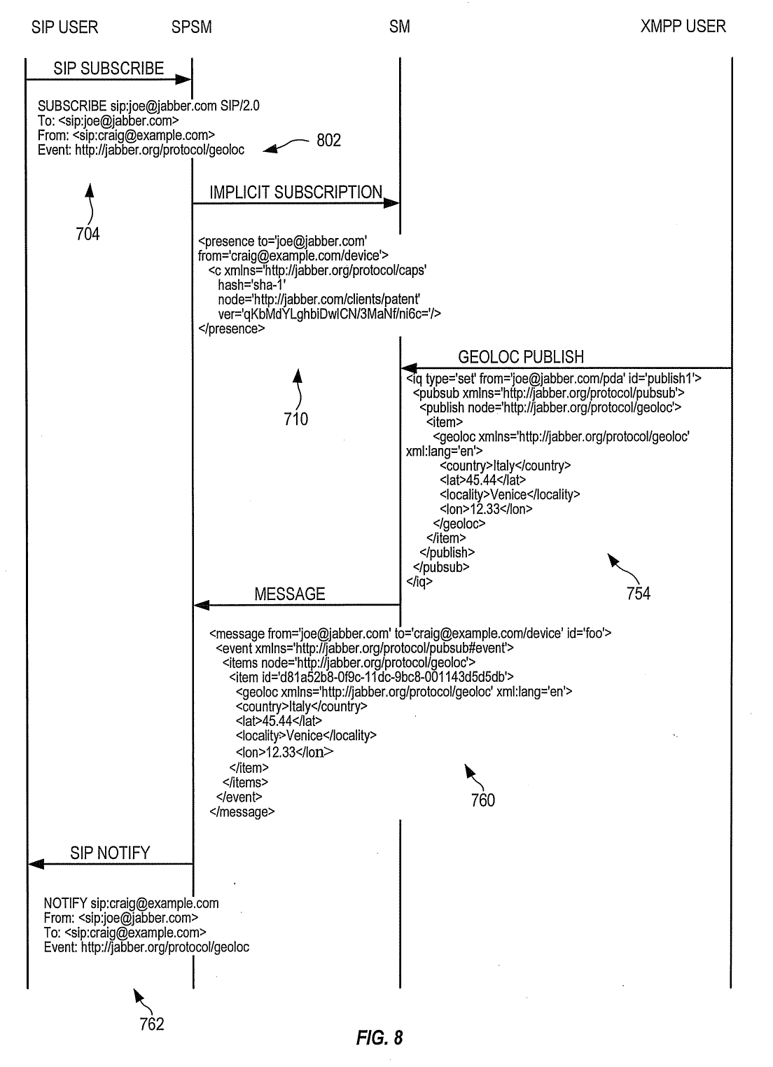

FIG. 7 is a block diagram showing a SIP watcher 702 subscribing to geo-location (geoloc) information of XMPP presentity Joe 552 (i.e., “joe@jabber.com”). FIG. 8 is a data flow diagram illustrating exemplary protocol translation during the information exchange of FIG. 7. FIGS. 7 and 8 are best viewed together with the following description.

SPSM 404 allows presence information within SM 520 to be received by a watcher 702 within SIP environment 501. In particular, SPSM 404 translates a SIP subscribe request 704 indicating an interest in geoloc information of XMPP presentity Joe 552 by SIP watcher 702.

In one example of operation, watcher 702 sends SIP subscribe message 704 to SPSM 404 where it is translated into an implicit subscription 710 to XMPP presentity Joe's 552 geoloc node 724 within PEP 520. Geoloc node 724 has a name of “http://jabber.org/protocol/geoloc”, in this example.

In particular, within SIP subscribe message 704, SPSM 404 determines that the specified ‘Event’ name 802 is an address (e.g., a jabber address) and therefore translates SIP subscribe message 704 into implicit subscription 710 for processing by PEP 522.

Upon receipt, PEP 522 processes implicit subscription 710 and stores information of SIP watcher 702 as subscription information 722 in association with Joe's geoloc node 724.

Presentity Joe 552 sends a geoloc publish message 754 to PEP 522 to update geolocation information associated with Joe's geoloc node 724. PEP 522 then generates a message 760 addressed to watcher 702 based upon subscription information 722. Message 760, containing updated geo-location information of Joe's geoloc node 724, is received by SPSM 404 (since it is addressed to a SIP entity) and translated into a SIP notify message 762, which is sent to watcher 702. Thus, watcher 702 may subscribe to, and receive notifications from, nodes within XMPP environment 519.

Within the SIP event framework, a template-package has all the properties of a regular SIP event package, however, it is generally associated with some other event package, and can be applied to any event package, including the template-package itself. Watcher information is a particular example of such a template-package and is denoted by the token ‘.winfo’.

The ‘.winfo’ template-package is used within SIP environment 501 to support presence authorization. When user A subscribes to the presence of user B, the subscription may need to be authorized. Frequently, that authorization needs to occur through direct user intervention. Thus, user B needs to become aware that a presence subscription has been requested. By allowing user B's client software to subscribe to the watcher information for the presence of user B, any changes (e.g., the addition of a subscriber) to the presence of user B results in a notification being sent to user B. In other words, the ‘.winfo’ (watcher info) generally indicates who is currently seeing a particular node (bit of presence) for implicitly subscribed users.

Within XMPP environment 519, presence is not stored within PEP 522. However, a ‘.winfo’ node may be stored within PEP in association with each presence node (e.g., presence node 530) of SM 520. As shown in FIG. 7, a presence.winfo node 728 is associated with presence node Joe 530. A presence.winfo node may be automatically created upon creation of a presence node. Since a user may also subscribe to information of the first .winfo node, a second .winfo node may be created upon the first subscription to the first .winfo node.

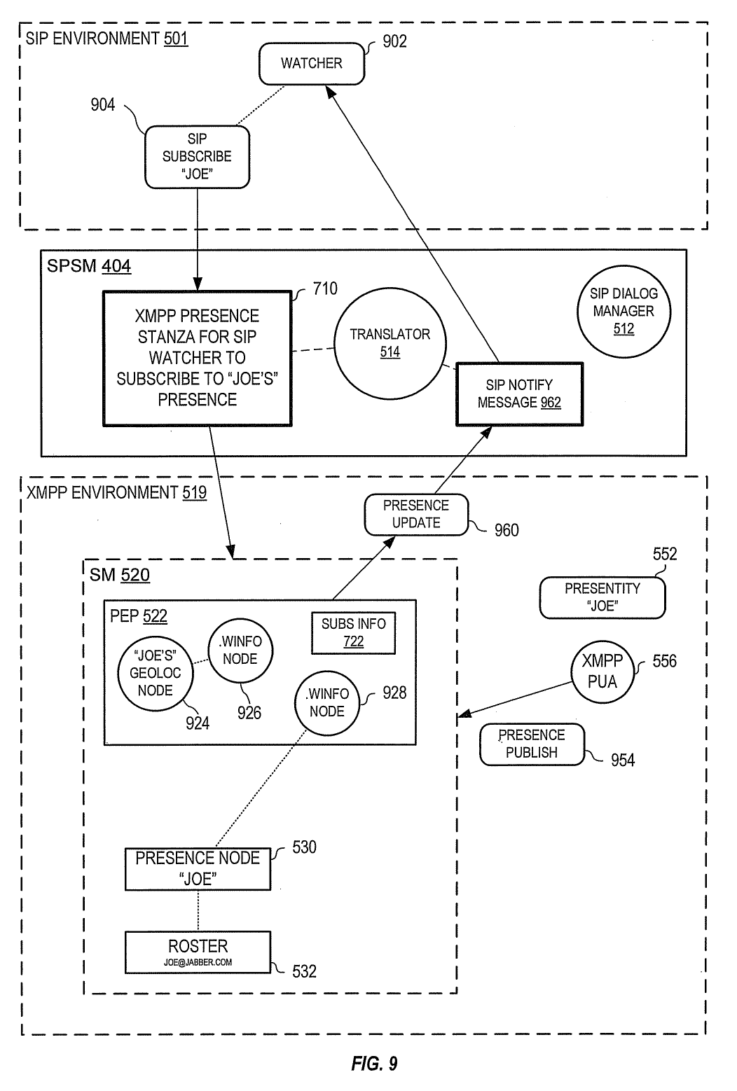

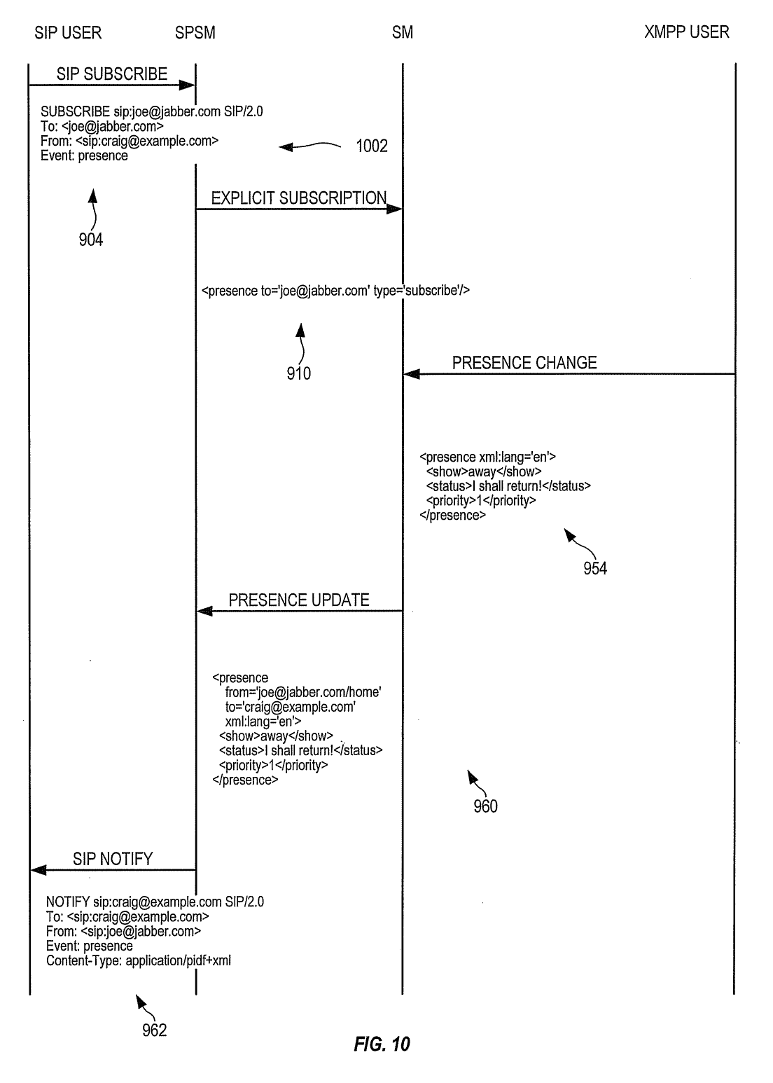

Since presence is not stored within PEP 522, subscriptions from watcher 702 to presence of presentity Joe 552 are handled differently than subscriptions to nodes (e.g., geoloc node 724) within PEP 522. FIG. 9 is a block diagram showing a SIP watcher 902 subscribing to presence information of XMPP presentity Joe 552. FIG. 10 is a data flow diagram illustrating exemplary protocol translation during the information exchange of FIG. 9.

In particular, FIG. 9 shows SPSM 404 providing presence information from XMPP environment 519 to a watcher 902 within SIP environment 501. FIG. 10 shows exemplary information exchanged between SIP watcher 902, SPSM 404, SM 520 and XMPP PUA 556. Since, within XMPP environment 519, presence is handled independently of other published information, SPSM 404 specifically identifies SIP subscriptions to XMPP presence and translates these SIP subscriptions accordingly.

In the example of FIGS. 9 and 10, a watcher 902 within SIP environment 501 subscribes to presence information of presentity “Joe” 552 within XMPP environment 519 by sending a SIP subscribe message 904 to SPSM 404. SPSM 404 determines that the subscription is for XMPP presence and translates SIP subscribe message 904 into an explicit presence subscription 910 to subscribe SIP watcher 902 to XMPP presentity Joe's 552 presence node 530 within SM 520.

In particular, within SIP subscribe message 904, SPSM 404 determines that the ‘Event’ name 1002 is a presence address (e.g., a jabber presence address) and therefore translates SIP subscribe message 904 into explicit presence subscription 910 for processing within XMPP environment 519. SM 520 receives explicit subscription 910 and searches for authorization for SIP watcher 902 within roster 532 associated with presence node 530 of XMPP presentity Joe 552.

When presence status of presentity 552 changes, XMPP PUA 556 sends a presence publish message 954 to SM 520. SM 520 updates presence node 530 with this new presence information and SM 520, based upon roster 532, generates a presence update 960 addressed to SIP watcher 902. Since the session for SIP watcher 902 is hosted by SPSM 404, presence update 960 is handled by SPSM 404. In particular, SPSM 404 translates presence update 960 into SIP notify message 962 for delivery to watcher 902. As shown in FIG. 10, SIP notify message 962 may include relevant presence information of presence update 960.

To illustrate and simplify the techniques described herein (e.g., with particular reference again to the discussion regarding FIGS. 1-3B), FIG. 11 illustrates an example simplified procedure for generally translating between explicit and implicit pub-sub protocols in accordance with one or more embodiments described herein. The procedure 1100 starts at step 1105, and continues to step 1110, where a pub-sub server (e.g., 201 or 402) receives one of either an implicit publish-subscribe (pub-sub) subscribe request (“subscribe message”) 305 or an explicit pub-sub subscribe request 320 from a subscriber device. In step 1110, the pub-sub server may convert the received request into an opposite pub-sub subscribe request of either corresponding new explicit pub-sub subscribe requests 310 or corresponding new implicit pub-sub subscribe requests 325, respectively, as needed. According to the techniques described in detail above, then, the pub-sub server may, in step 1115, transmit either the new explicit pub-sub subscribe requests 310 to explicit publisher servers or implicit pub-sub subscribe requests 335 to implicit publisher servers. Subscribe responses may be received in step 1120, which are then converted to the original pub-sub model of the requesting subscriber in step 1125 (e.g., ignoring explicit responses if the original model is implicit, or generating responses if there are none received from implicit servers for an explicit model of operation), and transmitted to the subscribed in step 1130. The simplified procedure 1100 may then end in step 1135.

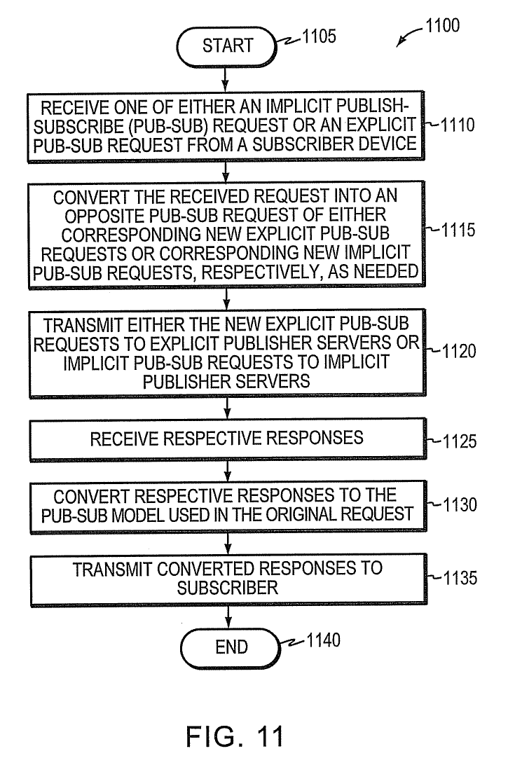

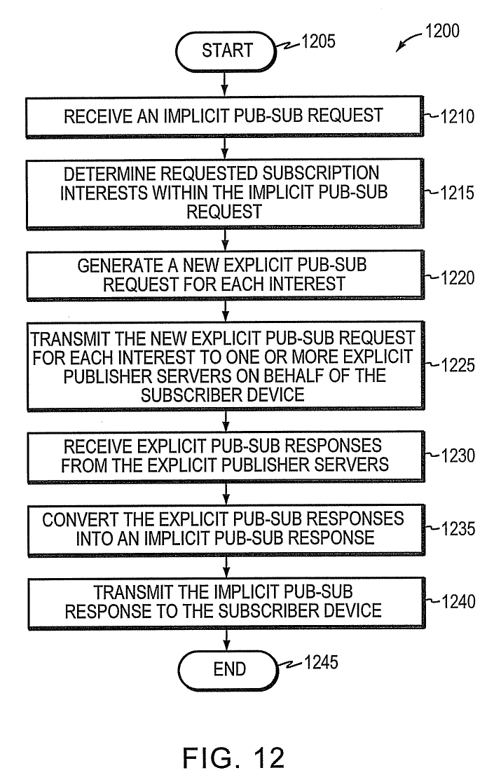

In particular, FIG. 12 illustrates an example procedure for translating from an implicit pub-sub protocol to an explicit pub-sub protocol in accordance with one or more embodiments described herein (e.g., a specific embodiment of procedure 1100 of FIG. 11, above). The procedure 1200 starts at step 1205, and continues to step 1210, where the pub-sub server receives an implicit pub-sub subscribe request 305. In step 1215, the server may determine a set of requested subscription interests within the implicit pub-sub subscribe request, and may correspondingly generate a new explicit pub-sub subscribe request 310 for each interest in step 1220. The new explicit pub-sub subscribe requests 310 may be transmitted in step 1225 for each interest to one or more explicit publisher servers 135 on behalf of the subscriber device. Further, in step 1230, the server may receive explicit pub-sub subscribe responses 312 from the explicit publisher servers, and may then convert the explicit pub-sub subscribe responses (including any explicit subscribe response internally generated) into an implicit pub-sub subscribe response 307 in step 1235 (e.g., assuming the implicit protocol utilizes responses). The implicit pub-sub subscribe response 307 may be transmitted to the subscriber device in step 1240, and the more detailed procedure 1200 ends in step 1245 (notably, with conventional implicit-to-implicit server operation being performed in parallel for implicit device servers).

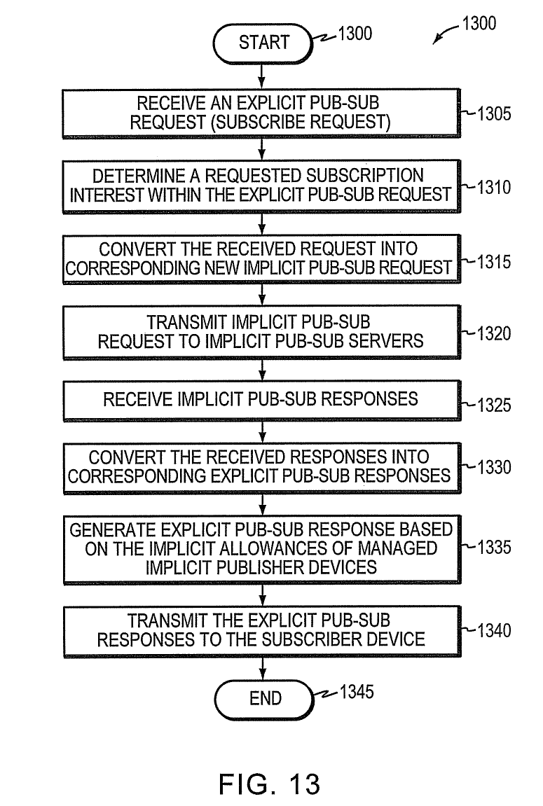

Conversely, FIG. 13 illustrates an example procedure for translating from an explicit pub-sub protocol to an implicit pub-sub protocol in accordance with one or more embodiments described herein (e.g., another specific embodiment of procedure 1100 of FIG. 11, above). The procedure 1300 starts at step 1305, and continues to step 1310, where the server receives an explicit pub-sub subscribe request 320, and may determine, in step 315, a requested subscription interest within the explicit pub-sub subscribe request (e.g., location). In step 1320, the server may convert the received subscribe request 320 into a corresponding new implicit pub-sub subscribe request 325, and may transmit the request 325 to implicit servers (130) in step 1325. The implicit subscribe responses may then be received from the implicit servers in step 1330, and translated into explicit subscribe responses in step 1335. Further, by determining the implicit allowances of managed implicit publisher devices (e.g., from “publish messages”) the server 201 may generate explicit subscribe responses for implicit attached devices as well in step 1340 (or for implicit servers who do not send a response, accordingly). The explicit subscribe responses may then be transmitted to the explicit requesting device in step 1345. The procedure 1300 may then end in step 1350 (notably, with conventional explicit-to-explicit server operation being performed in parallel for explicit device servers).

Advantageously, therefore, the novel techniques described herein translate between explicit and implicit pub-sub protocols in a computer network. By translating between the protocols, the novel techniques allow for publisher and subscriber devices (i.e., their servers) of the different protocols to coexist in the network. In particular, the techniques described above may be applied to pub-sub messages pertaining specifically to presence information, as well as other types of pub-sub information.

While there have been shown and described illustrative embodiments that translate between explicit and implicit pub-sub protocols in a computer network, it is to be understood that various other adaptations and modifications may be made within the spirit and scope of the present invention. For example, the embodiments have been shown and described herein using certain explicit and implicit pub-sub protocols (e.g., SIP and XMPP). However, the embodiments of the invention in their broader sense are not so limited, and may, in fact, be used with other explicit and/or implicit pub-sub protocols, as may be appreciated by those skilled in the art. Also, the use of presence information as a pub-sub distributed content is merely one example of pub-sub operation, and other content may advantageously utilize the techniques above (e.g., sensors and data collection and distribution). Further while the embodiments described above reference a centralized pub-sub server federation, other proxy devices may be utilized to translate the protocols, and the proxy device need not maintain/serve any particular information (e.g., obtaining the pub-sub information from another device/server for use with translation, etc.).

The foregoing description has been directed to specific embodiments of this invention. It will be apparent, however, that other variations and modifications may be made to the described embodiments, with the attainment of some or all of their advantages. For instance, it is expressly contemplated that the components and/or elements described herein can be implemented as software being stored on a tangible computer-readable medium (e.g., disks/CDs/etc.) having program instructions executing on a computer, hardware, firmware, or a combination thereof. Accordingly this description is to be taken only by way of example and not to otherwise limit the scope of the invention. Therefore, it is the object of the appended claims to cover all such variations and modifications as come within the true spirit and scope of the invention.

What is claimed is:

1. A method, comprising:
receiving a publish-subscribe (pub-sub) subscribe request from a subscriber device at a translating pub-sub server in a computer network, the received request according to an original pub-sub model;
converting the received subscribe request into a pub-sub subscribe request of a second pub-sub model; and
transmitting the converted received subscribe request to publisher servers operating according to the second pub-sub model.

2. The method as in claim 1, wherein the received pub-sub subscribe request is an implicit pub-sub subscribe request, the method further comprising:
determining requested subscription interests within the implicit pub-sub subscribe request;
generating a new explicit pub-sub subscribe request for each interest; and
transmitting the new explicit pub-sub subscribe request for each interest to one or more explicit publisher servers on behalf of the subscriber device.

3. The method as in claim 2, further comprising:
receiving explicit pub-sub subscribe responses from the one or more explicit publisher servers at the translating pub-sub server; and
ignoring the explicit pub-sub subscribe responses.

4. The method as in claim 1, wherein the subscriber device operates implicitly according to an Extensible Messaging and Presence Protocol (XMPP).

5. The method as in claim 4, wherein the subscriber device operates implicitly according to a personal eventing via pub-sub (PEP) extension to XMPP.

6. The method as in claim 1, further comprising:
generating a third pub-sub subscribe response based on publisher information of publisher devices managed by the translating pub-sub server; and
transmitting the third pub-sub subscribe response to the subscriber device on behalf of the publisher devices managed by the pub-sub server according to the original pub-sub model.

7. The method as in claim 1, wherein the subscriber device operates explicitly according to a Session Initiation Protocol (SIP).

8. The method as in claim 1, wherein the received pub-sub subscribe request is an explicit pub-sub subscribe request, the method further comprising:
generating explicit pub-sub subscribe responses according to the original pub-sub model; and
transmitting the explicit pub-sub subscribe responses from the translating pub-sub server to the subscriber device.

9. The method as in claim 1, further comprising:
determining that the translating pub-sub server is interconnected with a second translating pub-sub server;
determining which pub-sub model to use for communications with the second translating pub-sub server; and
transmitting the pub-sub subscribe request to the second translating pub-sub server according to either the original pub-sub model or second pub-sub model based on the determination.

10. The method as in claim 9, wherein the determination is based on one of either the original pub-sub model or a configured default pub-sub model.

11. An apparatus, comprising:
one or more network interfaces configured to communicate with one or more subscriber devices and one or more publisher devices in a computer network;
a processor coupled to the network interfaces and configured to execute one or more processes; and
a memory configured to store a process executable by the processor, the process when executed operable to:
receive a publish-subscribe (pub-sub) subscribe request from a subscriber device, the received request according to an original pub-sub model;
convert the received subscribe request into a pub-sub subscribe request of a second pub-sub model; and
transmit the converted received subscribe request to publisher servers operating according to the second pub-sub model.

12. The apparatus as in claim 11, wherein the original pub-sub model is selected from a group consisting of: an explicit pub-sub protocol and an implicit pub-sub protocol; and wherein the second pub-sub model is selected from a group consisting of: an implicit pub-sub protocol and an explicit pub-sub protocol, respectively.

13. The apparatus as in claim 11, wherein the received pub-sub subscribe request is an explicit pub-sub subscribe request, the process when executed further operable to:
generate explicit pub-sub subscribe responses according to the original pub-sub model; and
transmit the explicit pub-sub subscribe responses to the subscriber device.

14. A method for translating event data between a session initiation protocol (SIP) and an Extensible Messaging and Presence Protocol (XMPP), the method comprising:
mapping SIP events for publishing and subscribing into personal eventing via pub-sub (PEP) events for publishing and subscribing using XMPP; and
mapping XMPP events for publishing and subscribing into SIP events for publishing and subscribing using SIP.

15. The method of claim 14, further comprising
receiving a SIP publish event via SIP; and
translating, based upon a type of the SIP publish event, a SIP extensible markup language (XML) of the SIP publish event into an XMPP XML stanza that utilizes a PEP service to publish a PEP node to represent the SIP publish event.

16. The method of claim 14, further comprising:
receiving an XMPP publish event;
generating an XMPP message to each subscribed watcher; and
translating the XMPP message into a SIP Notify message for delivery to each subscribed watcher if each corresponding subscribed watcher is subscribed via SIP.

17. The method of claim 14, further comprising:
receiving a SIP subscribe request to an XMPP event of an XMPP presentity; and
translating the SIP subscribe request into an XMPP extensible markup language (XML) stanza that is an implicit subscription to a PEP node of the XMPP presentity within a PEP service.

18. A system for translating presence data between a session initiation protocol (SIP) based presence and an Extensible Messaging and Presence Protocol (XMPP) based presence, the system comprising:
an XMPP presence server configured to provide the XMPP based presence;
at least one SIP presence source configured to provide the SIP based presence; and
a SIP presence services module (SPSM), located within the XMPP presence server, configured to map between SIP presence and XMPP presence.

19. The system of claim 18, wherein the XMPP presence server is further configured to implicitly publish SIP meta-information for XMPP presence within a personal eventing via pub-sub (PEP) service.

20. The system of claim 19, wherein the SIP meta-information comprises one or more nodes within the PEP service, each node configured to represent a SIP template-package.

21. The system of claim 20, wherein the SIP template-package comprises SIP watcher information.

22. The system of claim 19, wherein the XMPP presence is stored external to the PEP service.
